(19) United States
(12) Patent Application Publication
(10) Pub. No.: US 2004/0224417 A1
(43) Pub. Date: Nov. 11, 2004

(54) Ultraviolet lamp performance measurement

(76) Inventor: Ziyi Wang, Fort Collins, CO (US)

Correspondence Address: DUFT SETTER OLLILA & BORNSEN LLC, 2060 BROADWAY, SUITE 300, BOULDER, CO, 80302, US

(21) Appl. No.: 10/834,632

(22) Filed: Apr. 29, 2004

Related U.S. Application Data
(60) Provisional application No. 60/467,011, filed on May 1, 2003.

(51) Int. Cl. G01N 27/00

(52) U.S. Cl. 436/39; 436/171; 436/149

(57) ABSTRACT

A system and method for the determination of the UV energy level for a UV lamp is disclosed. The conductivity of a water sample is measured and then the water sample is exposed to radiation from a UV lamp. The temperature of the water may also be measured or the temperature may be controlled. The rate of change of the conductivity of the water sample is measured during the exposure of the water to the radiation from the UV lamp. Using the rate of change in the conductivity of the water sample, it can be determined when the UV energy level from the lamp falls below a predetermined threshold.

### RELATED APPLICATIONS

This application claims the benefit of U.S. Provisional Application No. 60/467,001, filed May 1, 2003 with inventor Ziyi Wang.

### BACKGROUND OF THE INVENTION

1. Field of the Invention

The invention is related to the field of ultraviolet (UV) lights, and in particular, to determining the output of the UV energy in an ultraviolet lamp.

2. Statement of the Problem

Total Organic Carbon (TOC) analyzers measure the TOC content of water using an Ultraviolet lamp. U.S. Pat. No. 4,868,127 entitled “Instrument for measurement of the organic carbon content of water” filed on Dec. 5, 1986, discloses such a TOC measurement system and is hereby incorporated by reference for all that it teaches. Over time, the output of UV energy from the lamp diminishes. One cause of the reduction in UV energy is due to the mercury in the UV lamp migrating toward the lamp handle. The loss of mercury in the active area of the lamp degrades the amount of UV light produced by the lamp. The lamp may still produce argon light which is mostly infrared, but no longer produces a sufficient amount of UV energy. Without adequate UV light, the TOC analyzer provides inaccurate TOC measurements.

TOC analyzers do not currently track the performance of their UV lamps, so they cannot indicate when the performance of their UV lamp becomes inadequate. Currently, it is recommended that the UV lamp be replaced every six months to avoid inaccurate TOC measurement. Unfortunately, lamps with adequate performance may be replaced prematurely, or lamps may fail prior to the six month period and provide inaccurate measurements. A UV sensor may be added to the TOC analyzer, but that adds cost. In addition to increased cost, UV sensors also degrade over time and may not accurately indicate the operating status of the UV lamp.

Therefore there is a need for a system and method for determining when a UV lamp is no longer producing UV energy above a predetermined threshold.

### SUMMARY OF THE INVENTION

A system and method for the determination of the UV energy level for a UV lamp is disclosed. The conductivity of a water sample is measured and then the water sample is exposed to radiation from a UV lamp. The conductivity of the water sample is measured during the exposure of the water to the radiation from the UV lamp. The temperature of the water is measured or controlled at a predetermined value. Using the rate of change in the conductivity of the water sample, or the rate of change in the temperature compensated conductivity, or the rate of change in a derived TOC value based on conductivity and temperature, it can be determined when the UV energy level from the lamp falls below a predetermined threshold.

### BRIEF DESCRIPTION OF THE DRAWINGS

FIG. 1 is a functional block diagram of a UV measurement system in an example embodiment of the invention.

FIG. 2a is a chart of the TOC of water vs. time, in an example embodiment of the invention.

FIG. 2b is a chart of the first derivative of the TOC of water vs. time, in an example embodiment of the invention.

FIG. 3 is a graph of the scaled TOC rate of change vs. compensated initial conductivity in one example embodiment of the invention.

### DETAILED DESCRIPTION OF THE INVENTION

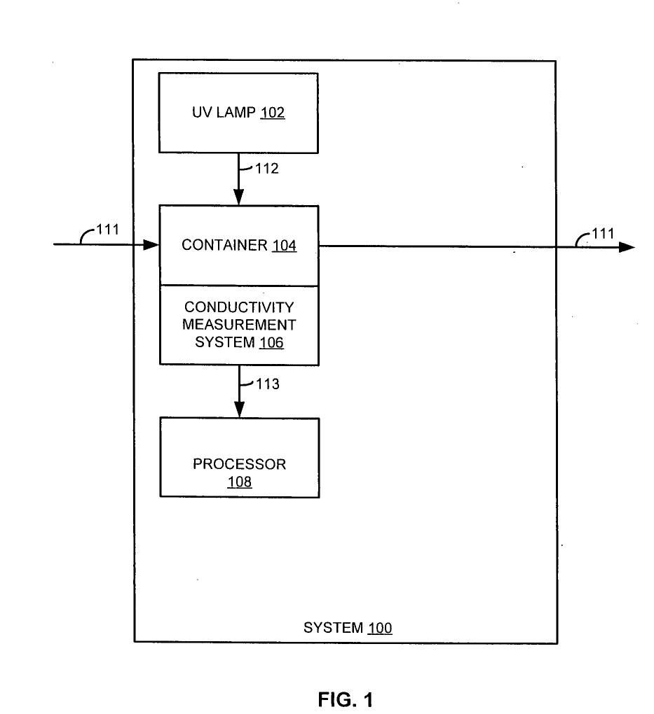

FIGS. 1-3 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

FIG. 1 illustrates a system 100 in an example embodiment of the invention. The system 100 includes Ultraviolet (UV) lamp 102, a container configured to hold a sample of water 104, a conductivity measurement system 106, and a processor 108. The system may also contain a temperature measurement system or a temperature control system (not shown).

In operation water is supplied to container 104. UV lamp shines light 112 into water 111 through a window in the container 104. Light 112 includes UV light that causes photo-catalytic oxidation of the organic matter in the water 111. The end product of the organic oxidation is carbon dioxide that dissolves in the water 111, causing a conductivity increase.

Conductivity measurement system 106 measures the conductivity of the water and transfers corresponding conductivity data 113 to processor 108. Conductivity measurement system 106 could be a pair of electrodes. Processor 108 processes conductivity data 113 to determine the performance of UV lamp 102. Processor 108 could be comprised of an integrated circuit chip, ASIC, DSP, programmable logic device, microprocessor, or some other form of suitable circuitry. The processor may be integrated into the system 100 (as shown) or may be a processor in an external device (not shown), for example a personal computer or the like.

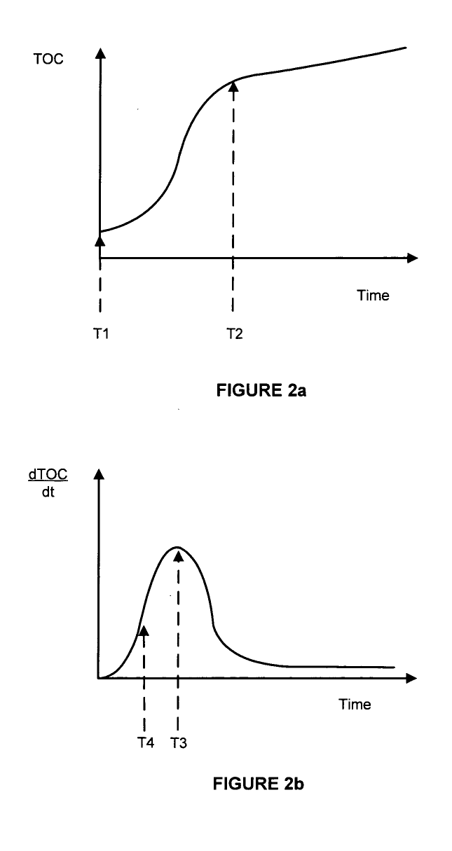

FIG. 2a is a graph plotting the derived TOC of the water vs. time. The derived TOC measurement is based on the conductivity measurement of the water. The change in conductivity vs. time would look the same as FIG. 2a, but may be offset by a scale factor. The TOC/conductivity of the water changes as the carbon oxidation process occurs. Note that the TOC/conductivity of the water increases from the initial measurement at time T1 until the time T2. Thus, the plot exhibits a rate of change or slope that reflects the increased TOC/conductivity of the water which is based on the increased oxidation of the carbon. Changes in the measured TOC/conductivity may be due to other effects in addition to the oxidation of the carbon, for example changes in the temperature of the water, measurement errors, or the like. After time T2, the TOC/conductivity continues to increase, although in other cases, the TOC/conductivity may flatten out, decrease, or otherwise fluctuate after time T2.

FIG. 2b is a graph plotting the first derivative of the TOC vs. time plotted in FIG. 2a. The first derivative is equivalent to the rate of change or slope of the TOC of the water over time. In one embodiment, processor 108 determines UV lamp 101 performance based on the rate of change or slope of the TOC of the water. In another embodiment, processor 108 determines UV lamp 101 performance based on the rate of change or slope of the conductivity of the water. At least 2 samples or measurements of the TOC/conductivity of the water must be taken to determine a rate of change of the TOC/conductivity of the water. In practice, a smoothing filter may be used to compensate for variations in the measurements of the TOC/conductivity of the water. The filter may require a number of samples or measurements be taken to fully populate the filter, before a rate of change can be determined.

Time T1 represents the time point when the TOC/conductivity of the water begins to change. An initial conductivity measurement may be taken before the water is exposed to the radiation from the UV lamp. As the UV energy produced by the UV lamp 102 degrades, the slope of the TOC/conductivity of the water flattens out to angle more toward the horizontal. Empirical testing can be performed to determine values for the rate of change that indicate adequate performance for UV lamp 102 and values for the rate of change that indicate inadequate performance for UV lamp 102.

In one example embodiment of the invention, the system would contain a temperature measurement system. The temperature measurement system would be configured to measure the temperature of the water in the container. The processor would use the temperature measurements to correct or compensate the conductivity measurements for changes in the temperature of the water. Other devices or hardware may correct the conductivity measurements for the temperature variations, instead of the processor. The rate of change of the temperature compensated conductivity may be derived to determine the output of the UV lamp.

In another example embodiment of the invention, the system would control the temperature of the water in the container. When the temperature of the water is controlled, the conductivity measurements of the water may not need to be adjusted for changes in the temperature of the water.

In another example embodiment of the invention, the system may contain a user interface (UI). When the processor determines that the UV energy level of the UV lamp has fallen below a predetermined threshold, the processor would use the UI to indicate that the lamp UV energy level no longer met requirements. The UI could be any means that can indicate that the UV level no longer meets the requirements. The UI could be some type of visual indicator, for example a warning light, a message on a display, a printed output, or the like. If the UI is a display, the message may indicate that the lamp should be replaced, or the message may display a warning. The UI could be some type of audio indicator, for example a warning tone, buzzer, or the like.

In another example embodiment of the invention, the system would contain a heater configured to heat the base or socket of the UV lamp. One of the failure modes of UV lamps is that the mercury in the lamp migrates from the hot active part of the lamp and condenses at the relatively cooler socket or base of the lamp. Once the mercury has migrated away from the active area of the lamp the UV energy produced by the lamp will be reduced. The lamp may still produce energy in other wavelengths, for example infrared (IR) radiation. By heating the base of the lamp the mercury may be reintroduced back into the active area of the lamp, thereby increasing the amount of UV energy produced by the lamp. Heating the base of the lamp may also prevent mercury migration away from the active area of the lamp. When the processor has determined that the energy level of the UV lamp no longer meets requirements, the processor may recondition the UV lamp by heating the UV lamp base. Other reconditioning steps may be possible. For example, when the UV lamp is mounted such that the lamp is hanging vertically from the lamp base, vibrating or shaking the lamp may cause some of the condensed mercury to fall back into the active area of the lamp. In another embodiment of the current invention, when the UV energy produced by the UV lamp is no longer adequate a second, or spare lamp could be used.

UV lamps are used in a number of applications. One application for UV lamps is in a total organic carbon (TOC) measurement system. When the UV lamp is part of a TOC measurement system the processor would also use the conductivity measurements to determine the total organic carbon content (TOC) in the water. TOC content is typically given in parts per billion (ppb). Another application for UV lamps is in water purification systems. In water purification systems the UV energy is used to destroy organic and non-organic substances in the water. In both types of systems it is important for the UV energy level from the UV lamp to be above a predetermined level.

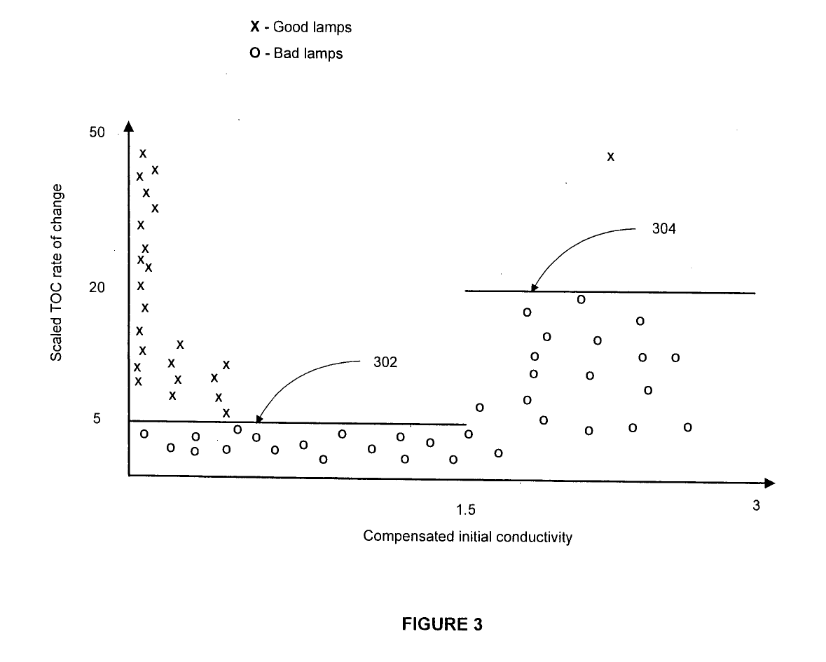

In a TOC measurement system the TOC measurements are proportional to the conductivity measurements. Therefore an algorithm that uses the TOC measurement could use the conductivity measurement as a replacement for the TOC measurement. Using the TOC measurements from a TOC measurement system, a number of test were run. The tests varied the concentration of carbon in the water, the initial conductivity of the water, the initial temperature of the water, the condition of the lamp, and the test system used. All of the TOC test systems used were A643 TOC units made by Anatel. FIG. 3 is a plot of the results of the experiments. FIG. 3 has been simplified for clarity and is a representation of the results from the tests preformed. On the vertical axis the scaled TOC rate of change is plotted and on the horizontal axis the compensated initial conductivity is plotted. The compensated initial conductivity is the initial conductivity measurement made before UV lamp is on, corrected for the initial temperature. The scaled TOC rate of change is equal to the TOC rate of change divided by the square root of the compensated initial conductivity (see equation 1).

$$scaledTOCrateofchange = \frac{TOCrateofchange}{\sqrt{compensatedinitialconductivity}} \qquad ( 1 )$$

As can be seen by FIG. 3, the difference between a good lamp and a bad lamp can be detected based on the scaled TOC rate of change and the initial conductivity of the water. Scaling the TOC rate of change allows a constant threshold to be used. Two different constant thresholds are used. Which constant threshold to be used is dependent on the temperature compensated initial conductivity of the water. Let (f) equals the slope of the running TOC divided by the square root of the compensated initial conductivity. If the compensated initial conductivity is less than or equal to 1.5 microsiemens per centimeter (μs/cm), and if (f) is less than 5 (equivalent to threshold 302), then the UV lamp 101 has inadequate performance. If the compensated initial conductivity is greater than 1.5 ms/cm, and if (f) is less than 20 (equivalent to threshold 304), then the UV lamp 101 has inadequate performance. Otherwise the lamp has adequate performance. The un-scaled TOC rate of change and the initial conductivity of water may be used to determine the difference between a good lamp and a bad lamp by using a variable threshold, an equation relating the TOC rate of change to the initial conductivity of the water, or the like.

In the test systems, a measurement of the conductivity of the water was taken every one-half (0.5) seconds. A smoothing filter was also used. Under these conditions the rate of change in the measured conductivity could be determined after between 5 and 20 seconds. Once the rate of change for the conductivity of the water had been determined, the condition of the lamp can be determined. Using different measurement rates, changing the number of samples used in the filter, eliminating the filter, or changing the type of filter used may change the time required to determine the rate of change of the conductivity of the water. In one example embodiment of the current invention, the initial rate of change in the TOC of the water is used to determine the UV lamp performance. By using the initial rate of change, an indication that a lamp failure has occurred can be given before the full TOC measurement has been completed. This can save time in that some TOC measurements can take as long as 5 to 10 minutes to complete. In systems where TOC measurements are not being taken, for example water sterilization systems, measurement speeds may be important. In other embodiments, the rate of change used to determine the lamp condition may be some rate of change other than the initial rate of change, for example the maximum rate of change detected (time T4 in FIG. 2b).

Note that TOC measurement system 100 could operate in a similar fashion to that described above, except that water 111 flows continuously through container 104 for TOC measurements, and a valve (not shown) periodically stops the flow of water 111 for determining the performance of UV lamp 102.

In some examples, processor 108 could lengthen the time for determining the final TOC as the running TOC slope flattens or the TOC slope remains constant.

We claim:

1. A method, comprising:
measuring the conductivity of water;
exposing the water to light from a UV lamp;
measuring the conductivity of the water over a time period during which the water is exposed to the light;
determining when the energy level of UV light from the UV lamp is below a required amount, based on the measurements of the conductivity of the water.

2. The method of claim 1 further comprising:
communicating that the UV energy level of the UV lamp is below the required amount when the energy level of the UV light from the UV lamp is below the required amount.

3. The method of claim 2 where the communication is through a visual display.

4. The method of claim 2 where the communication is through an audio source.

5. The method of claim 2 where the communication is by indicating that the lamp should be replaced.

6. The method of claim 1 further comprising:
reconditioning the UV lamp when the energy level of the UV light from the UV lamp is below the required amount.

7. The method of claim 6 where the reconditioning comprises heating a socket end on the UV lamp.

8. The method of claim 1 where the determination of when the energy level of the UV lamp is below the required amount is based on a rate of change of the conductivity of the water.

9. The method of claim 8 where the determination of when the energy level of the UV lamp is below the required amount is also based on an initial conductivity of the water and where the UV lamp is part of a total organic carbon (TOC) measurement system and the TOC measurement is based on the measurement of the conductivity of the water.

10. The method of claim 9 where the energy level of the UV lamp is below the required amount when the rate of change of the TOC of the water divided by the square root of the temperature compensated initial conductivity of the water is less than approximately 5 and the temperature compensated initial conductivity of the water is less than or equal to approximately 1.5 microsiemens per centimeters (μs/cm).

11. The method of claim 9 where the energy level of the UV lamp is below the required amount when the rate of change of the TOC of the water divided by the square root of the temperature compensated initial conductivity of the water is less than approximately 20 and the temperature compensated initial conductivity of the water is greater than approximately 1.5 microsiemens per centimeters (μs/cm).

12. The method of claim 1 further comprising:
measuring the temperature of the water and correcting the conductivity measurements for the temperature of the water.

13. The method of claim 1 further comprising:
controlling the temperature of the water during the time period.

14. The method of claim 1 where the time period is between 5 seconds and 20 seconds.

15. The method of claim 1 where the time period is approximately 15 seconds.

16. The method of claim 1 where the time period is determined by a sample rate for the conductivity measurements.

17. The method of claim 16 where the time period is also determined by a number of samples needed to fill a filter used to determine a rate of change in the conductivity of the water.

18. The method of claim 1 where the UV lamp is part of a total organic carbon measurement system.

19. The method of claim 1 where the conductivity measurements are also used to determine a total organic carbon content in the water.

20. A method, comprising:
measuring the conductivity of a sample of water;
measuring the temperature of the sample of water;
correcting the conductivity measurements for the measured temperature;
exposing the sample of water to radiation from a UV lamp;
determining a rate of change in a derived total organic carbon of the sample of water while the sample of water is exposed to the radiation from the UV lamp;
determining when the UV lamp needs to be replaced, based on the rate of change in the conductivity of the water.

21. An apparatus, comprising:
a container configured to hold a sample of water;
a UV lamp configured to irradiate the sample of water held by the container;
a conductivity measurement system configured to measure the conductivity of the sample of water held by the container;
a processor configured to receive and process the conductivity measurements to determine when the UV energy produced by the UV lamp falls below a predetermined threshold.

22. The apparatus of claim 21 further comprising:
a temperature measurement system configured to measure the temperature of the sample of water held by the container, whereby the processor compensates the conductivity measurements for the measured temperature.

23. The apparatus of claim 21 further comprising:
a temperature control system configured to control the temperature of the sample of water held by the container.

24. The apparatus of claim 21 further comprising:
a user interface (UI), whereby the processor displays information on the UI indicating that the UV energy produced by the UV lamp has fallen below the predetermined threshold.

25. The apparatus of claim 21 further comprising:
a heater, whereby the processor heats a socket end of the UV lamp when the UV energy produced by the UV lamp has fallen below the predetermined threshold.

26. The apparatus of claim 21 where the conductivity measurements are also used to measure a total organic carbon content in the sample of water.

27. The apparatus of claim 21 where a measurement based on a rate of change of the conductivity of the sample of water is used to determine when the UV energy produced by the UV lamp has fallen below the predetermined threshold.

28. The apparatus of claim 27 where an initial conductivity of the sample of water is also used to determine when the UV energy produced by the UV lamp has fallen below the predetermined threshold.

29. The apparatus of claim 27 where the rate of change of the conductivity of the sample of water is determined by measuring the conductivity of the sample of water over a time period of between 5 and 20 seconds.

30. The apparatus of claim 21 where a continues flow of water through the container is periodically stopped to determine when the UV energy produced by the UV lamp falls below the predetermined threshold.

31. An apparatus, comprising:
a means for measuring the conductivity of a sample of water;
a means for measuring the temperature of the sample of water;
a means for correcting the conductivity measurements of the sample of water using the measured temperature of the sample of water;
a means for exposing the sample of water to energy from a UV lamp;
a means for determining a rate of change of the TOC of the sample of water during the time when the sample of water is exposed to the energy from the UV lamp;
a means for detecting when the UV lamp needs to be replaced as a function of the rate of change of the conductivity of the sample of water.

32. An apparatus, comprising:
a means for measuring the conductivity of a sample of water;
a means for measuring the temperature of the sample of water;
a means for correcting the conductivity measurements of the sample of water using the measured temperature of the sample of water;
a means for exposing the sample of water to energy from a UV lamp;
a means for determining a rate of change of the TOC of the sample of water during the time when the sample of water is exposed to the energy from the UV lamp;
a means for detecting when the UV lamp needs to be replaced as a function of the rate of change of the running TOC of the sample of water where the running TOC is derived from the conductivity and temperature measurements.
